(19) United States
(12) Patent Application Publication
(10) Pub. No.: US 2025/0044936 A1
(43) Pub. Date: Feb. 6, 2025

(54) DYNAMICALLY ADJUSTING DIGITAL KEYBOARD INTERFACE ON A COMPUTING DEVICE

(71) Applicant: International Business Machines Corporation, Armonk, NY (US)

(72) Inventors: Johnny Shieh, Austin, TX (US); Jessica Murillo, Round Rock, TX (US); Kelley Anders, East New Market, MD (US)

(21) Appl. No.: 18/362,105

(22) Filed: Jul. 31, 2023

(51) Int. Cl. G06F 3/04886; G06V 40/12

(52) U.S. Cl. CPC G06F 3/04886; G06V 40/12

(57) ABSTRACT

Dynamically adjusting dimensions of a key of a computer-generated keyboard interface of a computing device can include capturing, at a computer, biometric data based on use of a computer-generated keyboard interface by a user. The biometric data can include dimensional data about a digit of the user with respect to a digit impression of the digit on a key of a plurality of keys of the keyboard interface. The biometric data can be analyzed and the analysis can include comparing the biometric data of the digit to key dimensions of the key of the plurality of keys of the keyboard interface. A computer model can be generated based on the analysis of the biometric data, and the dimensions of the key adjusted based on the computer model.

### BACKGROUND

The present disclosure relates to adjusting a computer-generated keyboard interface.

Computing devices or smart devices can display a keyboard interface. These devices can provide auto-corrections when a user types using the keyboard interface. In one example, when a keyboard interface does not match a user's finger size, multiple keys and missed keystrokes can be the result.

### SUMMARY

The present disclosure recognizes the shortcomings and problems associated with current techniques for dynamically adjusting dimensions of a computer-generated keyboard interface. The present invention includes dynamically adjusting a computer-generated keyboard interface on a computing device.

In one example, a computer-generated model can receive data input of keystrokes of a user and simulate adjustments of a keyboard interface to compensate for missed keystrokes. Such a model can be used to implement adjustment to the keyboard interface. Such adjustments to the digital keyboard interface on a tablet or smartphone can discourage mistyping that leads to misspelling and other typos.

In an aspect according to the present invention, a computer-implemented method a computer implemented method for dynamically adjusting dimensions of a key of a computer-generated keyboard interface of a computing device includes the following operations. The method includes capturing, at a computer, biometric data based on use of a computer-generated keyboard interface by a user of the keyboard interface, the keyboard interface being generated by a device having a computer, and the biometric data includes dimensional data about a digit of the user with respect to a digit impression of the digit on a key of a plurality of keys of the keyboard interface. The method includes analyzing, using the computer, the biometric data, the analysis including comparing the biometric data of the digit to key dimensions of the key of the plurality of keys of the keyboard interface. The method includes generating, using the computer, a computer model being based on the analysis of the biometric data; and adjusting, using the computer, the key dimensions of the key based on the computer model.

In a related aspect, the digit includes a fingertip of the user.

In a related aspect, the biometric data is captured using the digit impression.

In a related aspect, the biometric data includes a heat index based on the digit impression.

In a related aspect, the biometric data includes a pressure reading for the key in response to the digit pressing the key resulting in the digit impression.

In a related aspect, the method further includes capturing the biometric data from a plurality of digits of the user with respect to a plurality of digit impressions on the keyboard interface; analyzing, using the computer, the biometric data, the analysis including comparing the biometric data of the plurality of digits to key dimensions of the plurality of keys, respectively, of the keyboard interface; generating, using the computer, a computer model being based on the analysis of the biometric data for the plurality of digits; and adjusting the key dimensions for the plurality of keys, respectively, of the keyboard interface.

In a related aspect, the method further including: sending a notification to the device for display to the user for adjusting the key dimensions of the key; receiving a confirmation from the device that adjustment of the dimensions of the key is approved by the user; and initiating the adjustment of the dimensions of the key.

In a related aspect, the method further including: gathering data of keystrokes from the keyboard interface; analyzing missed and double keystrokes for the digit interacting with the keyboard interface; updating the computer model based on the missed and the double keystrokes; and adjusting the dimensions of the key of the keyboard interface based on the computer model.

In a related aspect, the key dimensions include multiple dimensions related to two dimensional space, respectively.

In a related aspect, wherein the key dimensions include multiple dimensions related to three dimensional space, respectively.

In a related aspect, the method further includes adjusting a space between the key and adjacent keys, based on the computer model.

In another aspect according to the present invention, a system for dynamically adjusting dimensions of a key of a computer-generated keyboard interface of a computing device, which includes a computer system. The computer system includes a computer processor, a computer-readable storage medium, and program instructions stored on the computer-readable storage medium being executable by the processor, to cause the computer system to perform the following functions to; capture, at a computer, biometric data based on use of a computer-generated keyboard interface by a user of the keyboard interface, the keyboard interface being generated by a device having a computer, the biometric data including dimensional data about a digit of the user with respect to a digit impression of the digit on a key of a plurality of keys of the keyboard interface; analyze, using the computer, the biometric data, the analysis including comparing the biometric data of the digit to key dimensions of the key of the plurality of keys of the keyboard interface; generate, using the computer, a computer model being based on the analysis of the biometric data; and adjust, using the computer, the key dimensions of the key based on the computer model.

In a related aspect, the digit includes a finger tip of the user.

In a related aspect, the biometric data is captured using the digit impression.

In a related aspect, the biometric data includes a heat index based on the digit impression.

In a related aspect, the biometric data includes a pressure reading for the key in response to the digit pressing the key resulting in the digit impression.

In a related aspect, the system further includes capturing the biometric data from a plurality of digits of the user with respect to a plurality of digit impressions on the keyboard interface; analyzing, using the computer, the biometric data, the analysis including comparing the biometric data of the plurality of digits to key dimensions of the plurality of keys, respectively, of the keyboard interface; generating, using the computer, a computer model being based on the analysis of the biometric data for the plurality of digits; and adjusting the key dimensions for the plurality of keys, respectively, of the keyboard interface.

In a related aspect, the system further includes sending a notification to the device for display to the user for adjusting the key dimensions of the key; receiving a confirmation from the device that adjustment of the dimensions of the key is approved by the user; and initiating the adjustment of the dimensions of the key.

In a related aspect, the system further includes gathering data of keystrokes from the keyboard interface; analyzing missed and double keystrokes for the digit interacting with the keyboard interface; updating the computer model based on the missed and the double keystrokes; and adjusting the dimensions of the key of the keyboard interface based on the computer model.

In another aspect according to the present disclosure, a computer program product for dynamically adjusting dimensions of a key of a computer-generated keyboard interface of a computing device includes a computer readable storage medium. The computer readable storage medium includes program instructions embodied therewith, the program instructions executable by a computer to cause the computer to perform functions, by the computer, comprising the functions to; capture, at a computer, biometric data based on use of a computer-generated keyboard interface by a user of the keyboard interface, the keyboard interface being generated by a device having a computer, the biometric data including dimensional data about a digit of the user with respect to a digit impression of the digit on a key of a plurality of keys of the keyboard interface; analyze, using the computer, the biometric data, the analysis including comparing the biometric data of the digit to key dimensions of the key of the plurality of keys of the keyboard interface; generate, using the computer, a computer model being based on the analysis of the biometric data; and adjust, using the computer, the key dimensions of the key based on the computer model.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. The drawings are discussed forthwith below.

FIG. 1 is a flow chart illustrating a method according to an embodiment of the present disclosure, for dynamically adjusting dimensions of one or more keys of a computer-generated keyboard interface.

FIG. 2 is a schematic block diagram illustrating a system according to an embodiment of the present disclosure, which can be used in conjunction with the method shown in FIG. 1, for dynamically adjusting dimensions of one or more keys of a computer-generated keyboard interface.

FIG. 3 is a schematic block diagram of a system, according to another embodiment of the present disclosure, for dynamically adjusting dimensions of one or more keys of a computer-generated keyboard interface, and including a control system.

FIG. 4 is a flow chart of a method, according to an embodiment of the present disclosure, which can use the system depicted in FIG. 3, for dynamically adjusting dimensions of one or more keys of a computer-generated keyboard interface of a computing.

FIG. 5 is a schematic block diagram depicting a computer system according to an embodiment of the disclosure, which includes cloud computing components and functions, and which can cooperate with the systems and methods shown in the figures and described herein.

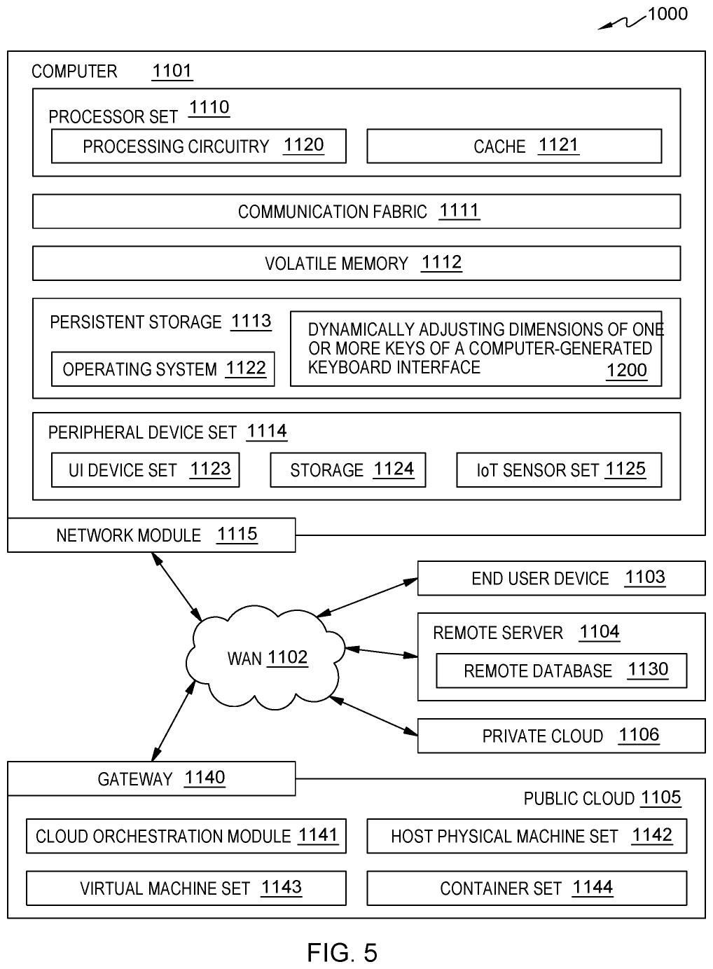

### DETAILED DESCRIPTION

The following description with reference to the accompanying drawings is provided to assist in a comprehensive understanding of exemplary embodiments of the invention as defined by the claims and their equivalents. The description includes various specific details to assist in that understanding, but these are to be regarded as merely exemplary, and assist in providing clarity and conciseness. Accordingly, those of ordinary skill in the art will recognize that various changes and modifications of the embodiments described herein can be made without departing from the scope and spirit of the invention. In addition, descriptions of well-known functions and constructions may be omitted.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

### EMBODIMENTS AND EXAMPLES

Embodiments and figures of the present disclosure may have the same or similar components as other embodiments. Such figures and descriptions illustrate and explain further examples and embodiments according to the present disclosure. Embodiments of the present disclosure can include operational actions and/or procedures. A method, such as a computer-implemented method, can include a series of operational blocks for implementing an embodiment according to the present disclosure which can include cooperation with one or more systems shown in the figures. The operational blocks of the methods and systems according to the present disclosure can include techniques, mechanism, modules, and the like for implementing the functions of the operations in accordance with the present disclosure. Similar components may have the same reference numerals. Components can operate in concert with a computer implemented method.

It is understood that a customer can be an individual, or a group of individuals, or a company or an organization.

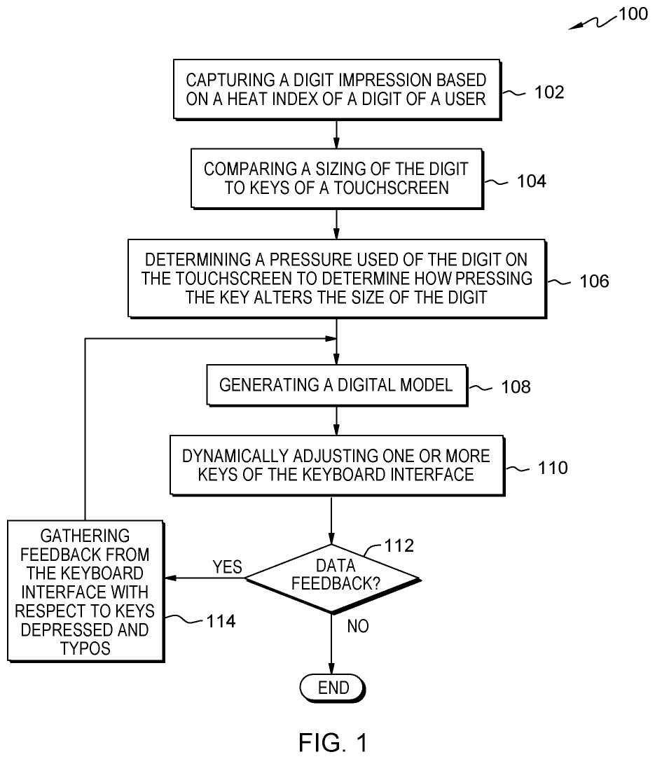

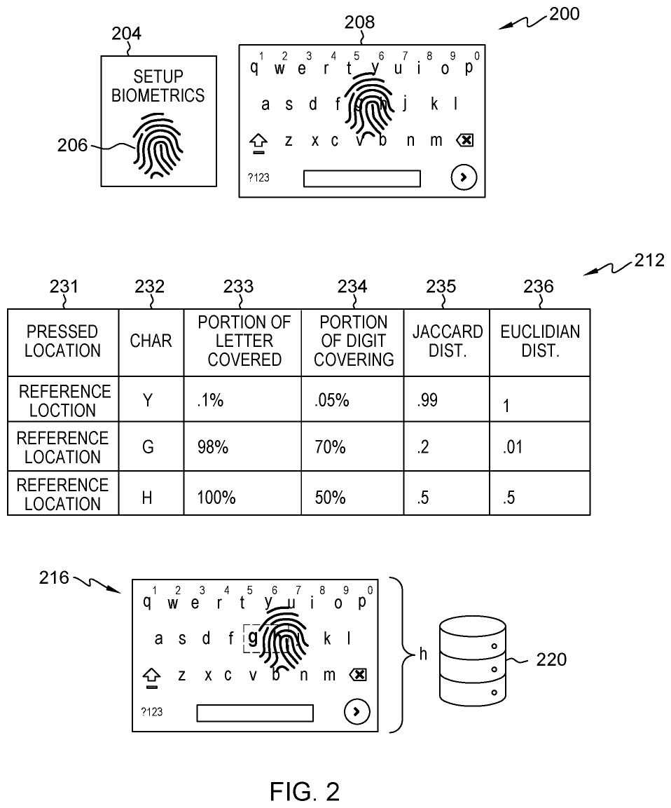

Referring to FIGS. 1 and 2, according to an embodiment of the present disclosure, a computer implemented method 100 for dynamically adjusting dimensions of a key of a computer-generated keyboard interface of a computing device, can use system 200 components shown in FIG. 2. The method includes capturing a digit impression based on a heat index of a digit of a user, as in block 102. The size of the digit is compared to keys of a touchscreen, as in block 104. The method includes determining a pressure used of the digit on the touchscreen to determine how pressing the key alters the size of the digit, as in block 106. The pressure can be determined using touchscreen technology and biometric technology.

In one example, a user can set up biometrics 204 by taping a finger until a fingertip impression 206, which may include all or part of a fingerprint, is captured on a digit of the user's hand.

The method includes generating a digital model, as in block 108. The digital model can include components including determining a portion of the letter covered by a portion of a digit of the user. The system can determine the frequency of the back space button being depression. The system can determine which combinations of letters that are depressed result in the backspace being depressed. The system can calculate a score based on the above and, in one example, calculate distance from a digit to a key using calculations generated using Euclidian distance or Jaccard distance (e.g., Jaccard distance measures dissimilarity between sample sets) to determine which surrounding keys should be expanded.

The system 100 can include dynamic adjustment of keys of the keyboard interface, based on the model, as in block 110. For example, when a user begins typing, the keys pressed or which are determined as pressed using the interface keyboard, and the ones surrounding the keys can be expanded, so that it's easier to click the correct key. In one example, after an initial typo the system can learn by updating the model. The keyboard interface can have keys that are dynamically adjusted, that is dimensions which are adjusted, resulting in an uneven or temporarily mis-shapen keyboard.

In one example, fingerprint overlap for a keyboard 208 including a fingerprint 206 can be quantified in a chart 212. A pressed location 231, related toa key and/or key character 232, and a portion of the letter covered 233 can be estimated. A portion of a digit covering the key 234, a Jaccard distance 235 and a Euclidian distance 236 can also be determined. The keyboard can dynamically adjust, for example, expanding one or more keys based on the model as shown in modified keyboard 216. The digit/fingerprint and key data related to the user's digit and the keys can be saved a database 220.

Data, at block 112, from the adjusted keyboard can be fed back into system, as in block 114. The system can learn which keys are more likely to be pressed correctly and/or incorrectly and feeds that data back into the model at block 108 so that accuracy is improved over time.

### Other Embodiments and Examples

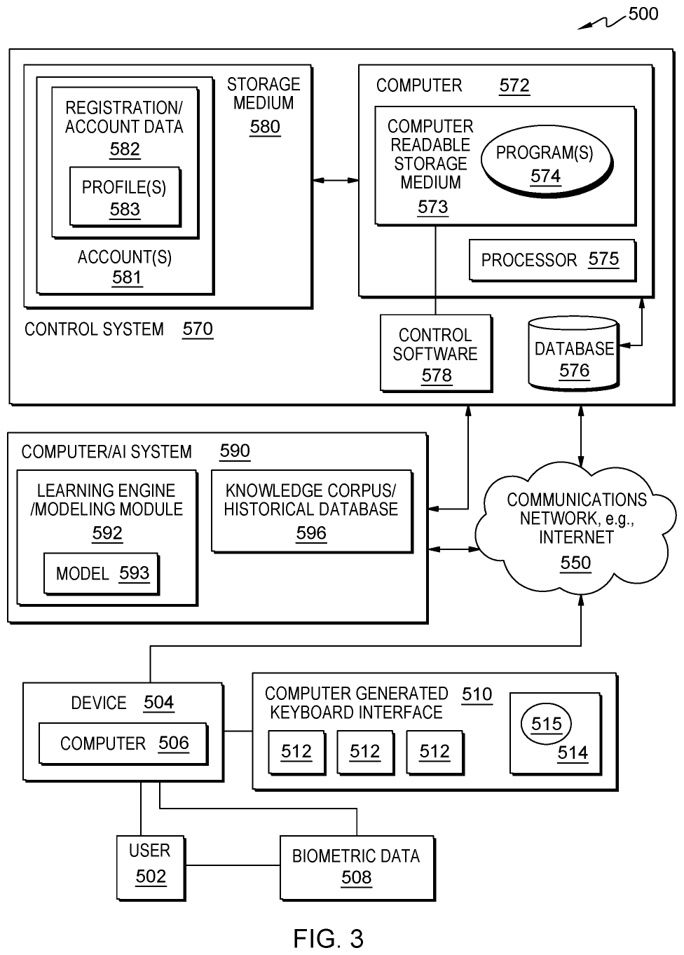

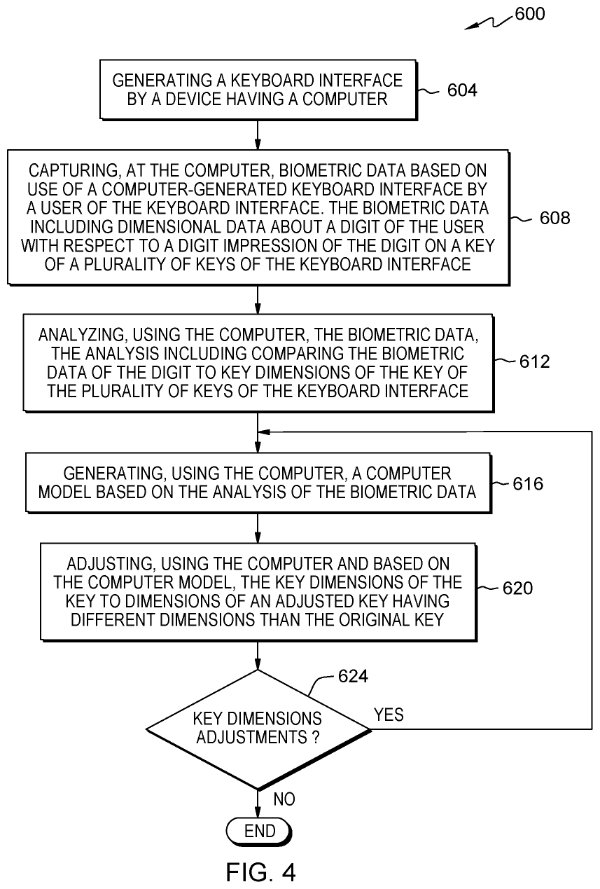

Referring to FIGS. 3 and 4, additionally, in one embodiment, a system 500, shown in FIG. 3 can be used to implement a method 600 (shown in FIG. 4), for dynamically adjusting dimensions (or the size) of a key of a computer-generated keyboard interface of a computing device. The method 600 includes generating a keyboard interface 510 by a device 504 having a computer 506, as in block 604.

The method 600 includes capturing, at the computer 506, biometric data 508 based on use of the computer-generated keyboard interface 510 by a user 502 of the keyboard interface 510, as in block 608. The biometric data 508 includes dimensional data about a digit of the user (such as a fingertip of the user) with respect to a digit impression 515 of the digit on a key 514 of a plurality of keys 512 of the keyboard interface 510, as in block 608. In one example, digits of the user can include finger tips for each of the fingers of the user. As the user presses one or more keys the fingertips can each leave a digital impression.

The method includes analyzing, using the computer 506, the biometric data 508. The analysis includes comparing the biometric data of the digit to key dimensions of the key 512 of the plurality of keys of the keyboard interface, as in block 612.

The method includes generating, using the computer, a computer model 593 based on the analysis of the biometric data, as in block 616.

The method includes adjusting, using the computer and based on the computer model, the key dimensions of the key to dimensions of an adjusted key 514 having different dimensions than the original key 512, as in block 620. The method determines when more key dimensions need to be adjusted at block 624, and when more key dimensions adjustment need to be made, the method returns to block 616. When no key dimensions adjustments are needed, the method ends.

In one example, the biometric data can be captured using the digit impression. For example, dimensions of a digital impression can be derived from a heat impression of a digit or finger tip of a user. Other biometric data can be captured, with permission of the user, such as digit pressure on a key, and may include all or part of a fingerprint.

In one example, the biometric data includes a heat index based on the digit impression. In another example, the biometric data includes a pressure reading for the key in response to the digit pressing the key resulting in the digit impression.

In another example, the method can further include capturing the biometric data from a plurality of digits of the user with respect to a plurality of digit impressions on the keyboard interface. The method can include analyzing, using the computer, the biometric data, the analysis including comparing the biometric data of the plurality of digits to key dimensions of the plurality of keys, respectively, of the keyboard interface. The method can include generating, using the computer, a computer model being based on the analysis of the biometric data for the plurality of digits, and adjusting the key dimensions for the plurality of keys, respectively, of the keyboard interface.

In another example, the method can further include sending a notification to the device for display to the user for adjusting the key dimensions of the key. The method can include receiving a confirmation from the device that adjustment of the dimensions of the key is approved by the user, and initiating the adjustment of the dimensions of the key.

In another example, the method can further include gathering data of keystrokes from the keyboard interface, and analyzing missed and double keystrokes for the digit interacting with the keyboard interface. The method can include updating the computer model based on the missed and the double keystrokes, and adjusting the dimensions of the key of the keyboard interface based on the computer model.

In another example, the key dimensions can include multiple dimensions related to two dimensional space, respectively.

In another example, the key dimensions can include multiple dimensions related to three dimensional space, respectively.

In another example, the method can further include adjusting a space between the key and adjacent keys, based on the computer model.

In one example, the method can further include generating, using the computer, a digital model. Generating a digital model using the computer can include receiving a set of updated biometric data including updated dimensional data about the digit of the user. The model can include updating the analyzing of the biometric data, generating an updated computer model based on the analysis of the biometric data. The method further includes updating the adjusting of the key dimensions of the key based on the updated computer model. In one example, the method can include iteratively generating the digital model to produce updated models.

In one example, by way of the embodiments disclosed herein, a computer implemented method is implemented for dynamically adjusting the dimensions or size, and could include spacing adjustments between keys, with respect to the keys of a computer generated touchscreen keyboard. The method includes capturing, at a computer, data based on a user of a computer generated touchscreen keyboard on a device. The data including data of the user's digits or finger tips. The data can include digital impression data from the keyboard which can include a heat index with respect to the digital impression. The digital impression can include a pressure reading for one or more of the user's digits, the data can also include biometric data from the user including the digital impression. The method includes analyzing the data to generate a computer model based on digit pressure and digit size from the data compared to key size of the touchscreen keyboard wherein the model adjusts the size of the touchscreen keys based on the data. The method includes sending a notification to the device for display to the user for adjusting the dimensions of the keys of the keyboard with respect to the model.

The method can include gathering data of keystrokes from the user using the touchscreen keyboard, analyzing missed and double keystrokes to generate an updated model. The method can include updating the model to adjust the size or dimensions of the keys of the touchscreen keyboard based on the analysis of missed and double keystrokes.

A computer implemented method as disclosed herein can include modeling, using the computer. The model can be generated using a learning engine or modeling module of a computer system which can be all or in part of an Artificial Intelligence (AI) system which communicates with the computer and/or a control system. Such a computer system can include or communicate with a knowledge corpus or historical database. In one example, an acceptable model can include a model meeting specified parameters. In another example, an acceptable model can be a model which has undergone several iterations of modeling. When the model is not acceptable, the method can return to return to a previous operation or proceed as directed, for example as represented by a operational block in a flowchart.

In one example according to the present disclosure, a method can generate a model, using a computer, which can include a series of operations. The model can be generated using a learning engine or modeling module of a computer system which can be all or in part of an Artificial Intelligence (AI) system which communicates with a computer and/or a control system. Such a computer system can include or communicate with a knowledge corpus or historical database.

### Other Examples and Embodiments

In another example, the computer 506 can include a processor and a computer readable storage medium where an application can be stored which can in one example, embody all or part of the method of the present disclosure. The application can include all or part of instructions to implement the method of the present disclosure, embodied in code and stored on a computer readable storage medium. The device 504 can include a display. The device 504 can operate, in all or in part, in conjunction with a remote server by way of a communications network 550, for example, the Internet.

The computer can be part of the mobile device, or a remote computer communicating with the mobile device. In another example, a mobile device and a remote computer can work in combination to implement the method of the present disclosure using stored program code or instructions to execute the features of the method(s) described herein. In one example, the device can include a computer having a processor and a storage medium which stores an application, and the computer includes a display. The application can incorporate program instructions for executing the features of the present disclosure using the processor. In another example, the mobile device application or computer software can have program instructions executable for a front end of a software application incorporating the features of the method of the present disclosure in program instructions, while a back end program or programs, of the software application, stored on the computer of the control system communicates with the mobile device computer and executes other features of the method. The control system and the device (e.g., mobile device or computer) can communicate using a communications network, for example, the Internet.

Methods and systems according to embodiments of the present disclosure, can be incorporated in one or more computer programs or an application stored on an electronic storage medium, and executable by the processor, as part of the computer on mobile device. For example, a mobile device can communicate with the control system, and in another example, a device such as a video feed device can communicate directly with the control system. Other users (not shown) may have similar mobile devices which communicate with the control system similarly. The application can be stored, all or in part, on a computer or a computer in a mobile device and at a control system communicating with the mobile device, for example, using the communications network, such as the Internet. It is envisioned that the application can access all or part of program instructions to implement the method of the present disclosure. The program or application can communicate with a remote computer system via a communications network (e.g., the Internet) and access data, and cooperate with program(s) stored on the remote computer system. Such interactions and mechanisms are described in further detail herein and referred to regarding components of a computer system, such as computer readable storage media, which are shown in one or more embodiments herein and described in more detail in regards thereto referring to one or more computers and systems described herein.

It is understood that the user device is representative of similar devices which can be for other users, as representative of such devices, which can include, mobile devices, smart devices, laptop computers etc.

Referring to the figures, and for example, FIG. 3, the system 500 includes a computer/AI (Artificial Intelligence) system 590 which can be integral to or communicating with a device, and communicate with other computers such as the computer 506 of the system 500. The computer 590 remote from the device 504 can electronically communicate, in all or in part, with a control system computer 572 as part of a control system 570. The control system 57 can include the computer 572 having a computer readable storage medium 573 which can store one or more programs 574, and a processor 575 for executing program instructions, and can also include control software 578 for managing the one or more programs. The control system can also include a storage medium which can include registration and/or account data 582 and user profiles 583 of users or entities (such entities can include robotic entities) as part of user accounts 581. User accounts 581 can be stored on a storage medium 580 which is part of the control system 570. The user accounts 581 can include registrations and account data 582 and user profiles 583. The control system can also include the computer 572 having a computer readable storage medium 573 which can store programs or code embedded on the storage medium. The program code can be executed by a processor 575. The computer 572 can communicate with a database 576. The control system 570 can also include a database 576 for storing all or part of such data as described above, and other data.

In one example, the biometric data 508 can be stored in the storage medium 580 with registration or account data 582 for a user.

The control system can also communicate with a computer system 590 which can include a learning engine/module 592 and a knowledge corpus or database 596. The computer system 590 can also communicate with the computer 506 of the device 504 and can be remote from the user device 504. In another example, the computer system 590 can be all or part of the control system, or all or part of the device 504. The depiction of the computer system 590 as well as the other components of the system 500 are shown as one example according to the present disclosure. One or more computer systems can communicate with a communications network 550, e.g., the Internet.

Thus, in one example, a control system can be in communication with a computer or device, and the computer can include an application or software. The computer, or a computer in a mobile device can communicate with the control system using the communications network. In another example, the control system can have a front-end computer belonging to one or more users, and a back-end computer embodied as the control system.

### Still Further Embodiments and Examples

Account data, for instance, including profile data related to a user, and any data, personal or otherwise, can be collected and stored, for example, in a control system. It is understood that such data collection is done with the knowledge and consent of a user, and stored to preserve privacy, which is discussed in more detail below. Such data can include personal data, and data regarding personal items.

In one example a user can register and have an account with a user profile on a control system. For example, data can be collected using techniques as discussed above, for example, using cameras, and data can be uploaded to a user profile by the user. A user can include, for example, a corporate entity, or department of a business, or a homeowner, or any end user, a human operator, or a robotic device, or other personnel of a business.

### Other Additional Embodiments and Examples

Additionally, methods and systems according to embodiments of the present disclosure can be discussed in relation to a functional system(s) depicted by functional block diagrams. The methods and systems can include components and operations for embodiments according to the present disclosure, and is used herein for reference when describing the operational steps of the methods and systems of the present disclosure. Additionally, the functional system, according to an embodiment of the present disclosure, depicts functional operations indicative of the embodiments discussed herein.

It is understood that the features shown in some of the figures, for example block diagrams, are functional representations of features of the present disclosure. Such features are shown in embodiments of the systems and methods of the present disclosure for illustrative purposes to clarify the functionality of features of the present disclosure.

It is also understood that the one or more computers or computer systems shown in the figures can include all or part of a computing environment and its components shown in another figure, for example, the computing environment 1000 can be incorporated, in all or in part, in one or more computers or devices shown in other figures and described herein. In one example, the one or more computers can communicate with all or part of a computing environment and its components as a remote computer system to achieve computer functions described in the present disclosure.

### More Additional Examples and Embodiments

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Referring to FIG. 6, a computing environment 1000 contains an example of an environment for the execution of at least some of the computer code involved in performing the inventive methods, such as dynamically adjusting dimensions of one or more keys of a computer-generated keyboard interface 1200. In addition to block 1200, computing environment 1000 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and block 1200, as identified above), peripheral device set 1114 (including user interface (UI), device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method may be distributed among multiple computers and/or between multiple locations. On the other hand, in this presentation of computing environment 1100, detailed discussion is focused on a single computer, specifically computer 1101, to keep the presentation as simple as possible. Computer 1101 may be located in a cloud, even though it is not shown in a cloud in FIG. 7. On the other hand, computer 1101 is not required to be in a cloud except to any extent as may be affirmatively indicated.

PROCESSOR SET 1110 includes one, or more, computer processors of any type now known or to be developed in the future. Processing circuitry 1120 may be distributed over multiple packages, for example, multiple, coordinated integrated circuit chips. Processing circuitry 1120 may implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set may be located “off chip.” In some computing environments, processor set 1110 may be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, at least some of the instructions for performing the inventive methods may be stored in block 1200 in persistent storage 1113.

COMMUNICATION FABRIC 1111 is the signal conduction paths that allow the various components of computer 1101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, the volatile memory is characterized by random access, but this is not required unless affirmatively indicated. In computer 1101, the volatile memory 1112 is located in a single package and is internal to computer 1101, but, alternatively or additionally, the volatile memory may be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 may be a read only memory (ROM), but typically at least a portion of the persistent storage allows writing of data, deletion of data and re-writing of data. Some familiar forms of persistent storage include magnetic disks and solid state storage devices. Operating system 1122 may take several forms, such as various known proprietary operating systems or open source Portable Operating System Interface type operating systems that employ a kernel. The code included in block 1200 typically includes at least some of the computer code involved in performing the inventive methods.

PERIPHERAL DEVICE SET 1114 includes the set of peripheral devices of computer 1101. Data communication connections between the peripheral devices and the other components of computer 1101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1123 may include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 may be persistent and/or volatile. In some embodiments, storage 1124 may take the form of a quantum computing storage device for storing data in the form of qubits. In embodiments where computer 1101 is required to have a large amount of storage (for example, where computer 1101 locally stores and manages a large database) then this storage may be provided by peripheral storage devices designed for storing very large amounts of data, such as a storage area network (SAN) that is shared by multiple, geographically distributed computers. IoT sensor set 1125 is made up of sensors that can be used in Internet of Things applications. For example, one sensor may be a thermometer and another sensor may be a motion detector.

NETWORK MODULE 1115 is the collection of computer software, hardware, and firmware that allows computer 1101 to communicate with other computers through WAN 1102. Network module 1115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101), and may take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 may be a client device, such as thin client, heavy client, mainframe computer, desktop computer and so on.

REMOTE SERVER 1104 is any computer system that serves at least some data and/or functionality to computer 1101. Remote server 1104 may be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data may be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs may be stored as images and may be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware, and firmware that allows public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud.

What is claimed is:

1. A computer implemented method for dynamically adjusting dimensions of a key of a computer-generated keyboard interface of a computing device, comprising:
capturing, at a computer, biometric data based on use of a computer-generated keyboard interface by a user of the keyboard interface, the keyboard interface being generated by a device having a computer, the biometric data including dimensional data about a digit of the user with respect to a digit impression of the digit on a key of a plurality of keys of the keyboard interface;
analyzing, using the computer, the biometric data, the analysis including comparing the biometric data of the digit to key dimensions of the key of the plurality of keys of the keyboard interface;
generating, using the computer, a computer model being based on the analysis of the biometric data; and
adjusting, using the computer, the key dimensions of the key based on the computer model.

2. The method of claim 1, wherein the digit includes a fingertip of the user.

3. The method of claim 1, wherein the biometric data is captured using the digit impression.

4. The method of claim 1, wherein the biometric data includes a heat index based on the digit impression.

5. The method of claim 1, wherein the biometric data includes a pressure reading for the key in response to the digit pressing the key resulting in the digit impression.

6. The method of claim 1, further comprising:
capturing the biometric data from a plurality of digits of the user with respect to a plurality of digit impressions on the keyboard interface;
analyzing, using the computer, the biometric data, the analysis including comparing the biometric data of the plurality of digits to key dimensions of the plurality of keys, respectively, of the keyboard interface;
generating, using the computer, a computer model being based on the analysis of the biometric data for the plurality of digits; and
adjusting the key dimensions for the plurality of keys, respectively, of the keyboard interface.

7. The method of claim 1, further comprising:
sending a notification to the device for display to the user for adjusting the key dimensions of the key;
receiving a confirmation from the device that adjustment of the dimensions of the key is approved by the user; and
initiating the adjustment of the dimensions of the key.

8. The method of claim 1, further comprising:
gathering data of keystrokes from the keyboard interface;
analyzing missed and double keystrokes for the digit interacting with the keyboard interface;
updating the computer model based on the missed and the double keystrokes; and
adjusting the dimensions of the key of the keyboard interface based on the computer model.

9. The method of claim 1, wherein the key dimensions include multiple dimensions related to two dimensional space, respectively.

10. The method of claim 1, wherein the key dimensions include multiple dimensions related to three dimensional space, respectively.

11. The method of claim 1, further comprising:
adjusting a space between the key and adjacent keys, based on the computer model.

12. A system for dynamically adjusting dimensions of a key of a computer-generated keyboard interface of a computing device, which comprises:
a computer system comprising; a computer processor, a computer-readable storage medium, and program instructions stored on the computer-readable storage medium being executable by the processor, to cause the computer system to perform the following functions to;
capture, at a computer, biometric data based on use of a computer-generated keyboard interface by a user of the keyboard interface, the keyboard interface being generated by a device having a computer, the biometric data including dimensional data about a digit of the user with respect to a digit impression of the digit on a key of a plurality of keys of the keyboard interface;
analyze, using the computer, the biometric data, the analysis including comparing the biometric data of the digit to key dimensions of the key of the plurality of keys of the keyboard interface;
generate, using the computer, a computer model being based on the analysis of the biometric data; and
adjust, using the computer, the key dimensions of the key based on the computer model.

13. The system of claim 12, wherein the digit includes a finger tip of the user.

14. The system of claim 12, wherein the biometric data is captured using the digit impression.

15. The system of claim 12, wherein the biometric data includes a heat index based on the digit impression.

16. The system of claim 12, wherein the biometric data includes a pressure reading for the key in response to the digit pressing the key resulting in the digit impression.

17. The system of claim 12, further comprising:
capturing the biometric data from a plurality of digits of the user with respect to a plurality of digit impressions on the keyboard interface;
analyzing, using the computer, the biometric data, the analysis including comparing the biometric data of the plurality of digits to key dimensions of the plurality of keys, respectively, of the keyboard interface;
generating, using the computer, a computer model being based on the analysis of the biometric data for the plurality of digits; and
adjusting the key dimensions for the plurality of keys, respectively, of the keyboard interface.

18. The system of claim 12, further comprising:
sending a notification to the device for display to the user for adjusting the key dimensions of the key;
receiving a confirmation from the device that adjustment of the dimensions of the key is approved by the user; and
initiating the adjustment of the dimensions of the key.

19. The system of claim 12, further comprising:
gathering data of keystrokes from the keyboard interface;
analyzing missed and double keystrokes for the digit interacting with the keyboard interface;
updating the computer model based on the missed and the double keystrokes; and
adjusting the dimensions of the key of the keyboard interface based on the computer model.

20. A computer program product for dynamically adjusting dimensions of a key of a computer-generated keyboard interface of a computing device, the computer program product comprising a computer readable storage medium having program instructions embodied therewith, the program instructions executable by a computer to cause the computer to perform functions, by the computer, comprising the functions to;
capture, at a computer, biometric data based on use of a computer-generated keyboard interface by a user of the keyboard interface, the keyboard interface being generated by a device having a computer, the biometric data including dimensional data about a digit of the user with respect to a digit impression of the digit on a key of a plurality of keys of the keyboard interface;
analyze, using the computer, the biometric data, the analysis including comparing the biometric data of the digit to key dimensions of the key of the plurality of keys of the keyboard interface;
generate, using the computer, a computer model being based on the analysis of the biometric data; and
adjust, using the computer, the key dimensions of the key based on the computer model.
